(19) United States
(12) Patent Application Publication
(10) Pub. No.: US 2003/0226738 A1
(43) Pub. Date: Dec. 11, 2003

(54) Discharge chute directional control system and method

(76) Inventors: Charles A. Eakins, Statesboro, GA (US); Gerald B. Ash, Newington, GA (US); George Leslie Todd, Metter, GA (US); Raiford Scott Webb, Statesboro, GA (US); Jimmy F. Clemens, Garfield, GA (US); Don E. Wilkes, Swainsboro, GA (US); Norman Buckhouse, Dublin, GA (US)

Correspondence Address: Alan R. Thiele, JENKENS & GILCHRIST, P.C., 1445 Ross Avenue, Suite 3200, Dallas, TX, 75202-2799, US

(21) Appl. No.: 10/396,664

(22) Filed: Mar. 25, 2003

Related U.S. Application Data
(60) Provisional application No. 60/367,583, filed on Mar. 26, 2002.

(51) Int. Cl. B65G 41/00

(52) U.S. Cl. 198/300

(57) ABSTRACT

The disclosed discharge chute directional control system and method is typically used on outdoor power equipment. By moving the position of the handle portion of a spring loaded handle assembly, the operator imparts rotation to a cam assembly. Rotation of the cam assembly imparts opposing forces on a pair of cables. These opposing forces, when applied to the rotational mounting of a discharge chute, change the orientation of the discharge chute.

### REFERENCE TO RELATED APPLICATION

This application claims priority from U.S. Provisional Patent Application Serial No. 60/367,583 filed Mar. 25, 2002.

### FIELD

The disclosed invention relates generally to outdoor power equipment; more particularly, the present invention pertains to outdoor power equipment designed for residential or light commercial use. The present invention is illustrated as having applicability to outdoor power equipment which includes a discharge chute such as typically found on either a snowblower or a mobile chipper.

### BACKGROUND

Many pieces of outdoor power equipment such as snowblowers, mobile chippers, lawnmowers, leaf sweepers, etc. include a discharge chute. For convenience to the operator of the piece of outdoor power equipment, the discharge chute needs to be rotated from one side to another to direct snow, clippings, leaves, chips, etc., to a desired location. This is best understood by considering the case of a sidewalk which needs to be cleared of snow. If the homeowner desires to throw the snow onto the lawn in front of the house, the discharge chute is directed, for example, to the right of the snowblower. When the operator reaches the end of the sidewalk and turns the snowblower around, the discharge chute will now be pointing to the street on the other side of the sidewalk. To continue blowing the snow onto the yard, the direction of the discharge chute must be reoriented from the right discharge position to a left discharge position. In still other applications, it may be necessary for the operator of the snowblower to throw the snow out more toward the front of the machine.

In the simplest of machines, no mechanism is provided which enables the operator to change the orientation of the discharge chute. In such simple machines, it is expected that once the operator brings the machine to a halt, the operator will manually re-position the discharge chute before the machine is turned around and caused to travel in the opposite direction. On some high-end machines, the discharge chute is reoriented by the use of a gear mechanism such as a worm drive. Thus, when it is necessary to rotate the chute, the worm or gear drive is turned. Because of engagement with the teeth on a worm gear with toothed ring or gear set at the bottom of the discharge chute, the orientation of the discharge chute can be changed by the turning of a drive rotational handle mechanically connected to the worm gear.

As can be easily understood by those of ordinary skill in the art, those pieces of outdoor power equipment which require manual adjustment of the discharge chute are inconvenient for the operator, as the operator must first leave a position behind the machine, then walk to the front of the machine to manually adjust the orientation of the discharge chute. Finally, the operator returns to a position behind the machine to continue operation. For high-end machines, the combination of a worm or gear drive with a toothed ring or gear set around the base of the rotatable chute brings a level of complexity to the piece of outdoor power equipment which causes its price to increase. Further adjustment of the orientation of the discharge chute is cumbersome and does not provide a positive method of adjustment. Specifically, it has been found that when extreme bumping or vibration occurs, the sensitivity of a worm or gear drive system to breakdown increases, as does the susceptibility to breakage or wear from inclement weather increases.

There is therefore needed a simple, low cost system which is easy to manufacture and install which can control the orientation of a rotatably mounted discharge chute on a piece of outdoor power equipment.

### SUMMARY OF THE INVENTION

The disclosed discharge chute directional control system and method provides a simple, low cost system to control the orientation of a rotatably mounted discharge chute on a piece of outdoor power equipment. While the disclosed system for orienting the discharge chute is shown mounted on a snowblower, those of ordinary skill in the art will understand that the present system may be used on a wide variety of different pieces of outdoor power equipment.

The operator, when desiring to change the orientation of the discharge chute, moves the handle portion of a locking, spring loaded handle assembly. The movement of a cam assembly mechanically connected to the handle portion imparts opposing forces on a pair of cables attached to the rotatably mounted discharge chute. The opposing forces on the rotatably mounted discharge chute re-orient the chute by rotation on its rotatable mounting.

### BRIEF DESCRIPTION OF THE DRAWING FIGURES

A still better understanding of the discharge chute directional control system and method of the present invention may be had by reference to the drawing figures, wherein:

FIG. 1 is a perspective view of a snowblower as the operator sees it when walking behind the snowblower;

FIG. 2 is a perspective view of the cam assembly;

FIG. 3 is a perspective view of the rotatably mounted discharge chute oriented to the left; and

FIG. 4 is a perspective view of the rotatably mounted discharge chute oriented partially to the right.

### DESCRIPTION OF THE EMBODIMENTS

In FIG. 1, the piece of outdoor power equipment 100 including a preferred embodiment of the present invention 10 is seen from the vantage point of the operator. The disclosed invention controls the orientation of the rotatably mounted chute 20. To use the disclosed invention, the chute 20 is re-oriented by grasping the knob 12 on top of the handle 14, depressing the spring loaded lever to dis-engage the cross bolt lock 16 from de-tented teeth 18. With the cross bolt lock 16 disengaged, the handle 14 is allowed to move from one end of its travel to the other. With the handle 14 in the left position or all the way forward, the rotatably mounted discharge chute 20 causes the snow to be thrown to the left. Similarly, when the handle 14 is moved to the right or all the way to the rear as shown in FIG. 1, the discharge chute 20 causes the snow to be thrown to the right. Directional control between the left and right limits is provided by multiple handle 14 positions between the left and right limits.

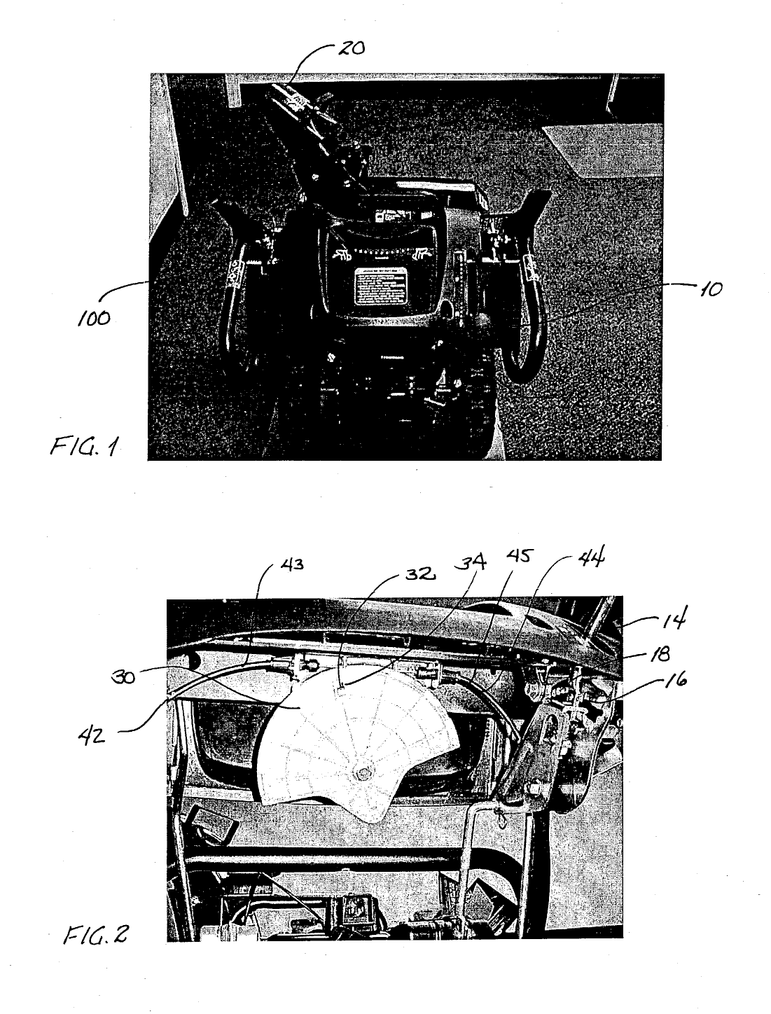

The mechanical operation of the directional control system 10 for a rotatably mounted discharge chute is best understood by reference to FIG. 2, wherein it may be seen that underneath the handle assembly is located a rotatable cam assembly 30. At the top of the cam assembly is a tang 32. The tang 32 extends through a hole 34 in the rotatable cam assembly 30. The tang 32 is mechanically connected to the bottom of the handle 14 so that when the handle 14 is moved, the tang 32 causes the rotatable cam assembly 30 to rotate. When the rotatable cam assembly 30 is caused to turn, the cables 42, 44 attached to either side of the rotatable cam assembly 30 will move in the same direction. Accordingly, when the rotatable cam assembly 30 is rotated in a clockwise fashion, when observed from the bottom as in FIG. 2, a tension force will be put on the left-most cable 42, and a compression force will be put on the right-most cable 44. Because each cable 42, 44 is enclosed in a sheath 43, 45 mounted at both ends, each cable will transmit a pushing force. These opposite forces are then transmitted by the pair of cables 42, 44 to the rotatably mounted discharge chute 20. Because of the opposite direction of these forces, a rotating motion will be imparted to the mounting assembly 50 for the discharge chute 20. This rotating motion will be around a central mounting pivot 52.

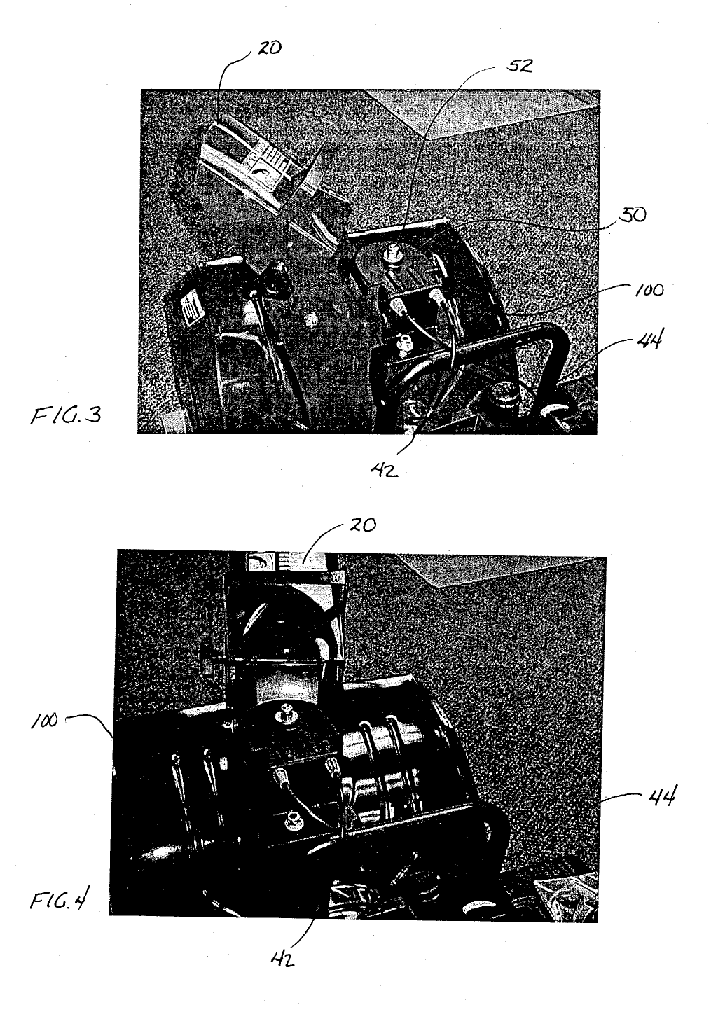

As shown in FIG. 3, the discharge chute has been moved to its left-most position by pushing the handle 14 forward.

As shown in FIG. 4, the discharge chute is moved partially to a position wherein the snow will be directed to the right of the snowblower by pulling the handle 14 rearward.

While the disclosed invention has been described for its utility in moving a discharge chute, numerous other applications are available for the present invention where a need exists to transport input from the operator by handle movement to forces needed to control the operation of a system on a piece of equipment.

While the present system and method has been disclosed according to the preferred embodiment of the invention, those of ordinary skill in the art will understand that other embodiments have also been enabled. Such other embodiments shall fall within the scope and meaning of the appended claims.

What is claimed is:

1. A directional control system for a rotatably mounted discharge chute on a piece of outdoor power equipment, said system comprising:
a locking, spring loaded handle assembly constructed and arranged for movement by the operator of the piece of outdoor power equipment to a position reflective of the position of the discharge chute with handle;
a rotatable cam assembly whose rotation is controlled by said handle assembly;
a pair of cables connected at one end to either sides of said rotatable cam assembly and at their second end to the rotatably mounted discharge chute;
whereby when said handle is un-locked and moved, said cam assembly is rotated, which rotation places opposing forces on said pair of cables, which opposing forces, when applied to the rotatably mounted discharge chute, causes the rotatably mounted discharge chute to be re-oriented.

2. The directional control system as defined in claim 1 wherein each cable in said pair of cables is sheathed.

3. A method for changing the directional orientation of a discharge chute on a piece of outdoor power equipment, said method comprising the steps of:
mounting a spring-loaded handle assembly for activation by the operator;
connecting said spring-loaded handle assembly to a rotatable cam assembly;
connecting a pair of cables to said rotatable cam assembly, one on either side;
connecting said pair of cables to a rotatable mounting for the discharge chute.
